(19) United States
(12) Patent Application Publication
(10) Pub. No.: US 2017/0324621 A1
(43) Pub. Date: Nov. 9, 2017

(54) MANAGING COMMUNICATION NETWORKS AND COMPARING NETWORK TOPOLOGIES

(71) Applicant: Cisco Technology, Inc., San Jose, CA (US)

(72) Inventors: Robert Stephen Estes, Santa Clara, CA (US); Dieter Wolfgang Famula, Colorado Springs, CO (US); Roma Bharat Bhansali, San Jose, CA (US); Sachin Saxena, Fremont, CA (US); Jacqueline A. Vasquez, San Jose, CA (US); Nikunj Desai, San Ramon, CA (US); Domenico Zini, Monza (IT); Steve Te Chiang, San Jose, CA (US); Srinivas Kodali, Santa Clara, CA (US)

(21) Appl. No.: 15/146,844

(22) Filed: May 4, 2016

(51) Int. Cl. H04L 12/24; G06T 11/20

(52) U.S. Cl. CPC H04L 41/12; G06T 11/206; H04L 41/06

(57) ABSTRACT

In some implementations, a method includes obtaining a first visual representation of a first network topology of a network and a second visual representation of a second network topology. The first network topology includes a first set of network devices and a first set of connections between the first set of network devices. The second network topology includes a second set of network devices and a second set of connections between the second set of network devices. The method also includes alternating between presenting the first visual representation and presenting the second visual representation based on user input.

### FIELD OF THE INVENTION

The present disclosure relates to management of communication networks and network devices, and in particular, to managing networks and comparing network topologies.

### BACKGROUND

Users, such as network administrators, often perform operation, administration, maintenance, and provisioning (OAMP) functions for various networks (e.g., computer networks or data networks). For example, network administrators may monitor and/or manage one or more networks. OAMP systems (e.g., software and/or hardware) may be used to monitor the status of network devices and/or monitor connections between network devices. OAMP systems may also be used to maintain one or more networks, perform maintenance on network devices, remove faulty network components, devices, or connections from service, and provision new network devices and network connections. OAMP systems may also allow users to identify, diagnose, and/or fix (e.g., troubleshoot) problems with one or more networks. For example, OAMP systems may allow a user (e.g., a network administrator) to determine that a network device has failed or a network connection has been disrupted and that the network is unable to perform a service (e.g., route video data) because the network device has failed or network connection has been disrupted.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings. The appended drawings, however, illustrate only some example features of the present disclosure and are therefore not to be considered limiting, for the description may admit to other effective features.

FIG. 1 is a block diagram illustrating a system architecture, in accordance with some embodiments.

FIG. 2A is a diagram illustrating an example graphical user interface, in accordance with some embodiments.

FIG. 2B is a diagram illustrating an example graphical user interface, in accordance with some embodiments.

FIG. 2C is a diagram illustrating an example graphical user interface, in accordance with some embodiments.

FIG. 3 is a flowchart representation of a method of comparing network topologies, in accordance with some embodiments.

FIG. 4 is a flowchart representation of a method of comparing network topologies, in accordance with some embodiments.

FIG. 5 is a block diagram of a computing device, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION OF EXAMPLE EMBODIMENTS

Numerous details are described herein in order to provide a thorough understanding of the illustrative implementations shown in the accompanying drawings. However, the accompanying drawings show only some example aspects of the present disclosure and are therefore not to be considered limiting. Those of ordinary skill in the art will appreciate from the present disclosure that other effective aspects and/or variants do not include all of the specific details described herein. Moreover, well-known systems, methods, components, devices and circuits have not been described in exhaustive detail so as not to unnecessarily obscure more pertinent aspects of the implementations described herein.

### Overview

Various implementations disclosed herein include apparatuses, systems, and methods for managing networks and/or comparing network topologies. A method may include obtaining a first visual representation of a first network topology of a network and a second visual representation of a second network topology. The first network topology includes a first set of network devices and a first set of connections between the first set of network devices. The second network topology includes a second set of network devices and a second set of connections between the second set of network devices. The method also includes alternating between presenting the first visual representation and presenting the second visual representation based on user input.

### DETAILED DESCRIPTION

As discussed above, OAMP systems (e.g., software and/or hardware) may be used to monitor, maintain, and/or troubleshoot problems with networks (e.g., computer networks or data networks). OAMP system may include hardware components (e.g., computing devices) and/or software components (e.g., applications, apps, etc.) that allow a user to view the topology of a network. The network devices and the connections between the network devices may be referred to as a topology or a network topology. The topology of a network may change over time. For example, new network devices may be added, existing network devices may fail or may be removed, connections between network devices may be removed, new connections between network devices may be formed, etc. The changes in the topology of the network may affect the operation and/or performance of the network. For example, if a network device fails, the network may be unable to route network traffic (e.g., data and/or packets) as quickly as before or may not be able to route network traffic at all. In another example, if a network device is added, new connections may cause network traffic to be routed inefficiently. Identifying changes in the topology of a network may allow a user (e.g., a system administrator) to more easily, quickly, and/or efficiently identify problems (or possible problems) within a network and address the problems.

In some embodiments, a system architecture may allow a user to determine and/or identify changes in the topology of a network more quickly and/or easily. The system architecture may periodically store data indicating the topology of a network (e.g., may store the topology of the network every hour, every twelve hours, every two days, etc.) or may store data indicating the topology of the network when the system architecture determines that the topology of the network has changed. The system architecture may allow users to compare visual representations of the topology of the network by alternating between presenting different visual representations. Alternating between presenting different visual representations may induce a persistence of vision effect (e.g., a blinking effect) which may allow a user to more quickly and/or easily identify differences between two different topologies of a network (as discussed in more detail below). For example, alternating between presenting different visual representations may allow a user to more easily identify differences between two different topologies of a network when the network includes a large number of network devices and/or connections (e.g., hundreds, thousands, etc., of devices and/or connections).

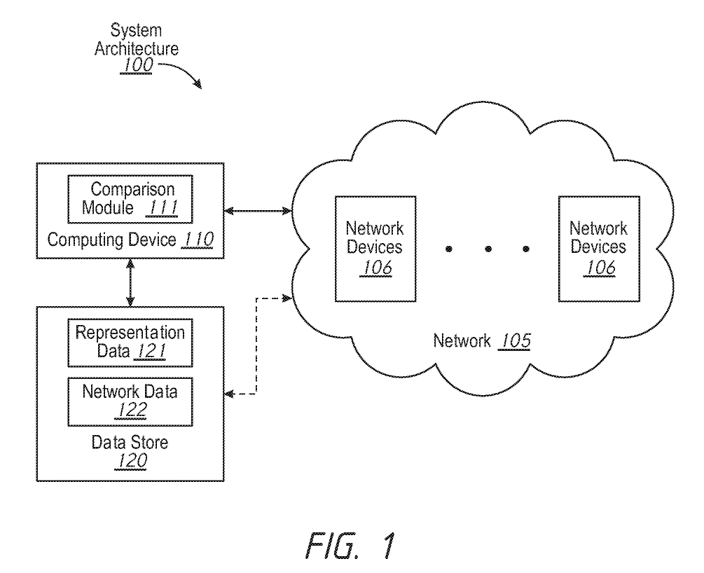

FIG. 1 is a block diagram illustrating a system architecture 100, in accordance with some embodiments. The system architecture includes a computing device 110, a data store 120, and a network 105. Examples of a computing device may include, but are not limited to, a rack-mount server, a router computer, a server computer, a personal computer, a mainframe computer, a smartphone, a personal digital assistant (PDA), a laptop computer, a tablet computer, a desktop computer, etc. In one embodiment, the computing device 110 and/or the comparison module 111 may be part of an OAMP system that allows a user (e.g., a network administrator) to monitor, maintain, and/or troubleshoot (e.g., identify, diagnose, fix, etc.) problems with the network 105. The network 105 may include one or more of a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), and/or a combination thereof.

The data store 120 may be may be a memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In one embodiment, the data store 120 may be directly coupled to the computing device 110 (as indicated by the solid line between the data store 120 and the computing device 110). In another embodiment, the data store 120 may be coupled to the computing device 110 via the network 105 (as indicated by the dashed line between the data store 120 and the network 105). The data store 120 includes representation data 121 and network data 122 (as discussed in more detail below).

In one embodiment, the network 105 may include various types and numbers of network devices 106. For example, the network 105 may include network switches, network routers, network hubs, blade switches, add-drop multiplexers, virtual devices (e.g., virtual routers, virtual switches, etc.), etc. The network devices 106 may be connected (e.g., coupled or interconnected) in various ways. The network 105 (and/or the network devices 106) may provide various services and/or perform various function/operations. For example, the network 105 may provide internet packet (IP) telephony services. In another example, the network 105 may provide video streaming (e.g., digital video streaming) services. In a further example, the network 105 may perform virtual private network (VPN) functions and/or load balancing functions.

As discussed above, one or more network devices 106 may be added, removed, reconfigured, and/or may fail (e.g., may crash, stop operating, operate outside of intended norm, etc.). As network devices 106 are added, removed, reconfigured, etc., the connections between the network devices 106 may be modified. For example, when a new network device 106 is added to the network 105, the new network device 106 may be connected to one or more other network devices 106 in the network 105 (e.g., new connections may be added to the network 105). In another example, when a network device 106 is removed from the network 105 (or when the network device 106 fails), the removed network device 106 may be disconnected from one or more other network devices 106 in the network 105 (e.g., network connections may be removed from the network 105). The network devices 106 and the connections between the network devices 106 may be referred to as a topology or a network topology of the network 105. Adding, removing, and/or reconfiguring network devices 106 may change the topology of the network 105 (e.g., may change the network topology). Adding and/or removing connections between the network devices 106 may also change the topology of the network 105.

In one embodiment, the network data 122 may include data that indicates the topologies of the network 105 at different times. For example, the comparison module 111 may determine the topology of the network 105 periodically (e.g., every hour, every day, etc.) and may store data indicative of the network topology during each period in the network data 122. In another example, the comparison module 111 may receive messages, signals, and/or other data when the topology of the network 105 is changed. For example, the comparison module 111 may receive a message each time a network device is added and/or removed. The comparison module 111 may also receive a message when a network device fails (e.g., when a first network device determines that a second network device has failed). The comparison module 111 may further receive a message when a connection between network devices is added, removed, or modified. The comparison module 111 may store data indicative of the network topology when the comparison module receives a message, signal, or other data indicating that the topology of the network 105 has changed. In one embodiment, a user may also store a current topology of the network in the network data 122. For example, the user may use the comparison module 111 to determine a current topology of the network and store data indicative of the current topology in the network data 122.

As illustrated in FIG. 1, the computing device 110 includes a comparison module 111. The comparison module 111 may allow a user (e.g., a network administrator) to manage a network and to identify changes in a network (as discussed in detail below). In one embodiment, the comparison module 111 may obtain a first visual representation of a first network topology and may obtain a second visual representation of a second network topology. The first network topology may include a first set of network devices and a first set of connections between the first set of network devices. The second network topology may include a second set of network devices and a second set of connections between the second set of network devices. The first network topology may be different from the second network topology. For example, the first network topology may include network devices and/or connections (between the network devices) that are not in the second network topology and vice versa. The first network topology and the second network topology may also be associated with different points in time. For example, the first network topology may be the topology of the network 105 during a first time T1 and the second network topology may be the topology of the network 105 during a second time T2.

In one embodiment, the first visual representation and the second visual representation may be 2-dimensional (2-D) representations and/or views of the first network topology and the second network topology, respectively. For example, the first visual representation may display network devices and/or connections between the network devices of the first network topology as a flat representation. In another embodiment, the first visual representation and the second visual representation may be 3-dimensional (3-D) representations and/or views of the first network topology and the second network topology, respectively. For example, the second visual representation may display network devices and/or connections between the network devices of the second network topology using an isometric view of the network devices and the connections.

In one embodiment, the comparison module 111 may obtain the first visual representation and the second visual representation by generating the first visual representation and second visual representation based on the network data 122 of the data store 120. The comparison module 111 may store the first visual representation and the second visual representation as part of the representation data 121 of the data store 120. This may allow the comparison module 111 to store (e.g., cache) the visual representations for later presentation/display. In another embodiment, the comparison module 111 may obtain the first visual representation and the second visual representation by accessing the data store 120. For example, the first visual representation and the second visual representation may be included in the representation data 121 of the data store 120. The first visual representation and the second visual representation may have been previously generated by the comparison module and/or another computing device (e.g., a server computer). The comparison module 111 may request and/or receive the first visual representation and the second visual representation from the data store 120.

In one embodiment, the comparison module 111 may obtain the first visual representation and the second visual representation based on user input identifying and/or selecting the first network topology and the second network topology. For example, comparison module 111 may provide a list of network topologies via a graphical user interface. The user may select the first network topology and the second network topology from the list of network topologies (as discussed in more detail below). The comparison module 111 may generate the first visual representation and the second visual representation based on the selected network topologies. The comparison module may also obtain the first visual representation and the second visual representation from the data store 120 (e.g., from the representation data 121 of the data store 120) based on the selected network topologies.

In one embodiment, the comparison module 111 may provide a graphical user interface (GUI) to a user (e.g., a network administrator), as discussed in more detail below. The graphical user interface may present the first visual representation and/or the second visual representation to the user (as discussed in more detail below). The comparison module 111 may alternate between presenting the first visual representation and presenting the second visual representation based on user input (e.g., based on user input received from a keyboard or mouse), as discussed in more detail below. The comparison module 111 may alternate between presenting the first visual representation and the second visual representation multiple times. In another embodiment, the comparison module 111 may alternate between presenting the first visual representation and the second visual representation periodically (e.g., may alternate every half second, every second, every 5 seconds, etc.).

In one embodiment, the first visual representation and the second visual representation may include a common set of network devices and/or a common set of connections. For example, a network device may be represented and/or included in both the first visual representation and the second visual representation. In another example, a connection between two network devices may be represented and/or included in both the first visual representation and the second visual representation. The comparison module 111 may present and/or display the common set of network devices and/or the common set of network connections at the same location. For example, a network device that is in both the first visual representation and the second visual representation (e.g., is common to both the first visual representation and the second visual representation) may be displayed at a same location/position within a GUI (as discussed below in more detail).

In one embodiment, the comparison module 111 may alternate between presenting the first visual representation and presenting the second visual representation at a rate or speed. The rate/speed of the alternating may induce (e.g., may be fast enough to induce) the persistence of vision effect in a user. As discussed above, the first network topology (displayed in the first visual representation) may be different from the second network topology (displayed in the second visual representation). For example, the first network topology may include a first network device that is not in the second network topology. As the comparison module alternates between presenting the first visual representation and presenting the second visual representation, the persistence of vision effect may cause the first network device to appear to blink or flash. The blinking effect caused by the persistence of vision of a user may allow the user to more quickly and/or easily identify differences between two network topologies. As discussed above, identifying the differences between two network topologies may allow the user to more easily, quickly, and/or efficiently identify problems (or possible problems) within the network 105 and address (e.g., fix) the problems.

In one embodiment, the comparison module 111 may allow a user to change the locations and/or positions in which the network devices and/or connections between the network devices are displayed within the first visual representation and the second visual representation. For example, a user may drag and drop an icon representing a network device to a different location and/or position within first visual representation and/or the second visual representation (as discussed in more detail below). In another embodiment, the icon may be presented and/or displayed in the different location/position in multiple visual representations when the icon is associated with a common network device (e.g., a network device that is included in the multiple visual representations).

In one embodiment, the comparison module 111 may determine whether the first visual representation and the second visual representations are comparable. For example, the comparison module 111 may determine the number of network devices and/or the number of connections that are common to the first visual representation and the second visual representation (e.g., number of network devices in the common set of network devices and/or number of connections in the common set of connections). If the number of network devices and/or the number of connections that are common to the first visual representation and the second visual representation is below a threshold (e.g., a threshold number, a threshold percentage), the comparison module 111 may determine that first visual representation and the second visual representation are not comparable. If the number of network devices and/or the number of connections that are common to the first visual representation and the second visual representation is greater than or equal to the threshold, the comparison module 111 may determine that first visual representation and the second visual representation are comparable.

In one embodiment, the comparison module 111 may adjust the zoom level of the first visual representation and/or the second visual representation based on user input. For example, the comparison module 111 may receive user input indicating that a user wants a closer view of a region of the first visual representation. The comparison module 111 may provide a closer view of the region of the first visual representation (e.g., may zoom in) via a GUI. In another example, the comparison module 111 may receive user input indicating that a user wants a farther view of a region of the first visual representation. The comparison module 111 may provide a farther view of the region of the first visual representation (e.g., may zoom out) via a graphical user interface.

In one embodiment, the comparison module 111 may identify one or more differences (e.g., a set of differences) between the first network topology and the second network topology. For example, the first visual representation may include a network device that is not included in the second visual representation. The comparison module 111 may provide an indication via a graphical user interface to indicate (e.g., to display or highlight) the one or more differences (between the first network topology and the second network topology) to a user, as discussed in more detail below.

In one embodiment, the comparison module 111 may receive user input indicating one or more annotations (e.g., notes, text, images, highlights, etc.) associated with one or more of the first visual representation and the second visual representation (as discussed in more detail below). For example, a user may add a note to the first visual representation to indicate the state of a first network device in the first visual representation. In another example, a user may highlight (e.g., highlight with a yellow color) a second network device and a network connection in the second visual representation.

Although FIG. 1 may refer to a first network topology, a second network topology, a first visual representation and a second visual representation, it shall be understood that the implementations, embodiments, and/or examples described herein may be applied to multiple network topologies (e.g., eight network topologies, fifteen network topologies) and/or multiple visual representations (e.g., eight visual representations, fifteen visual representations).

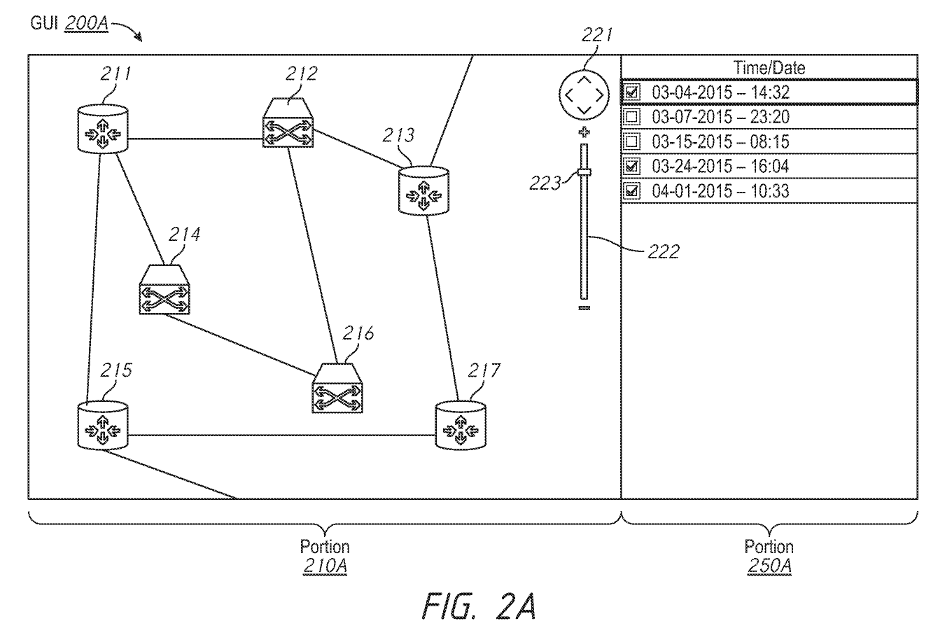

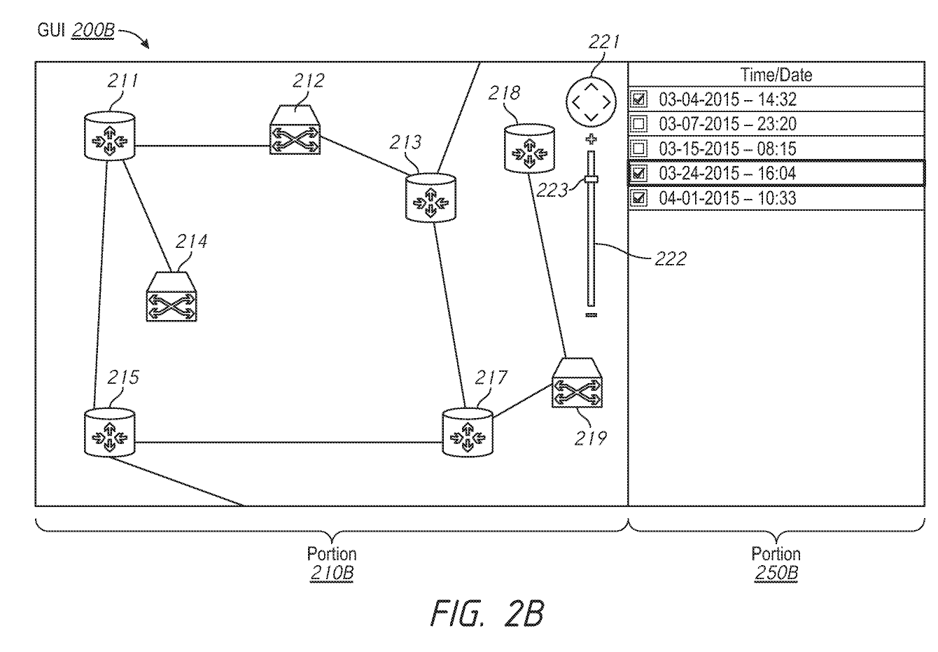

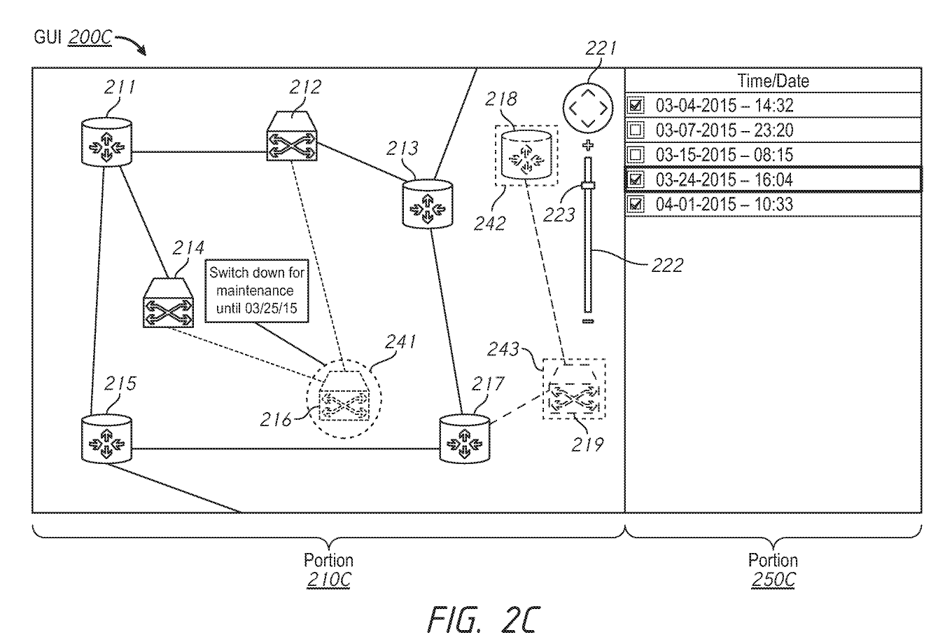

FIG. 2A is a diagram illustrating an example graphical user interface (GUI) 200A, in accordance with some embodiments. The GUI 200A may be presented and/or displayed by a comparison module (e.g., comparison module 111 illustrated in FIG. 1). For example, the comparison module may be an application (e.g., an app, a program, a software module/component) and/or a web browser that may present the GUI 200A in a window (e.g., an application window). The GUI 200A includes two portions, portion 210A and portion 250B.

The portion 210A of the GUI 200A may present and/or display a visual representation of a network topology. As discussed above, a network topology may include a set of network devices (e.g., routers, switches, etc.) and a set of connections between the network devices. The portion 210A may display a visual representation of the network topology and the visual representation may include shapes, colors, icons, images, text, etc., that represent the network devices and the connections of the network topology. The visual representations may be generated based on user input identifying and/or selecting one or more network topologies or may be previously generated (as discussed above). As illustrated in FIG. 2A, the portion 210A includes icons 211, 212, 213, 214, 215, 216, and 217. Each of the icons 211, 212, 213, 214, 215, 216, and 217 may represent a network device (e.g., a switch, a router, etc.) that is part of the network topology represented by the visual representation displayed and/or presented in portion 210A. The portion 210A also includes lines interconnecting the icons 211, 212, 213, 214, 215, 216, and 217 (as illustrated in FIG. 2A). The lines may represent connections between the network devices of the network topology represented by the visual representation displayed and/or presented in portion 210A. As illustrated in FIG. 2A, the visual representation (of a network topology) presented/displayed in portion 210A may be a 2-D representation. In other embodiments, the visual representation presented/displayed in portion 210A may be a 3-D representation (e.g., an isometric view of the network topology).

The portion 210A also includes button 221. In one embodiment, the button 221 may allow a user to change the view of the network topology displayed/presented in portion 210A. For example, if the user clicks (e.g., clicks using a mouse) on the right section of the button 221 (e.g., clicks on the right arrow in the button 221), the view of the network topology may shift and/or move towards the right. In another example, if the user clicks on the lower section of the button 221 (e.g., clocks on the down arrow in the button 521), the view of the network topology may shift and/or move downwards.

In one embodiment, the user may change the view of the network topology displayed/presented in portion 210A via a touch pad or touch screen without the use of button 221. For example, if the user swipes one or more fingers across the touch pad or touch screen, then the view of the network topology may shift and/or move in the corresponding direction.

The portion 210A also includes slider bar 222 and a slider 223. In one embodiment, the slider bar 222 and/or the slider 223 may allow a user to change the view of the network topology displayed/presented in portion 210A. For example, if the slider 223 is moved upwards (e.g., slid upwards) along the slider bar 222 (towards the plus symbol), the view of the network topology (displayed/presented in portion 210A) may zoom in. In another example, if the slider 223 is moved downwards (e.g., slid downwards) along the slider bar 222 (towards the minus symbol), the view of the network topology (displayed/presented in portion 210A) may zoom out.

In one embodiment, the user may zoom in or zoom out the view of the network topology displayed/presented in portion 210A via a touch pad or touch screen without the use of slide bar 222 and slide 223. For example, the user may zoom out via a “pinch” motion of fingers across the touch pad or touch screen or zoom in via a spreading motion of fingers across the touch pad or touch screen.

The GUI 200A also includes portion 250A. As illustrated in FIG. 2A, the portion 250A includes a list of network topologies (e.g., a list of five network topologies). Each network topology in the list of network topologies is associated with a date and/or time and may represent a snapshot of the network topology taken at that time. For example, the first network topology is associated with the date/time Mar. 4, 2015 at 14:32 (e.g., 2:32 PM), the second network topology is associated with the date/time Mar. 7, 2015 at 23:20 (e.g., 11:20 PM), etc. A snapshot of the network topology may also refer to network devices and/or network connections that are part of the network at a point in time (e.g., at a particular time). The snapshot of the network topology may be obtained (e.g., taken, captured, acquired, etc.) according to a schedule (as described above) and/or in response to a message/notification indicating a change to the network topology (as described above). Each network topology in the list of network topologies may be associated with a checkbox. The checkboxes may allow the user to select one or more of the network topologies in the list of network topologies. In one embodiment, when one network topology is selected, the portion 210A may present and/or display a visual representation for the selected network topology. In another embodiment, when multiple network topologies are selected, the portion 210A may present and/or display a visual representation for one network topology of the selected network topologies. For example, as illustrated in FIG. 2A, the first network topology, the fourth network topology, and the fifth network topology in the list of network topologies are selected (e.g., the respective checkboxes are checked or selected). A visual representation of the first network topology (e.g., the network topology associated with the date/time Mar. 4, 2015 at 14:32) is presented and/or displayed in the portion 210A, as indicated by the thicker rectangle (e.g., the bolded rectangle) around the first network topology.

In one embodiment, a user may change the location and/or position of an icon (e.g., an icon representing a network device) in the visual representation displayed and/or presented in the portion 210A. For example, the user may select the icon 213 displayed/presented in the portion 210A and may move the icon 213 towards the right (e.g., may drag and drop the icon 213 towards the right). Thus, the GUI 200A may allow the user to configure and/or customize the visual representation displayed/presented in the portion 210A.

In one embodiment, the location and/or position of an icon in the visual representation displayed and/or presented in the portion 210A may be changed via location and/or position data collected from the network. For example, the original position of icon 213 may be determined from location data (e.g., GPS data/coordinates, longitude/latitude, street address, etc.) received from the network about the network device represented by icon 213. Location data received at some later point in time may indicate that the network device represented by icon 213 got moved to a new location that corresponds to a new position in the visual representation displayed and/or presented in the portion 210A.

FIG. 2B is a diagram illustrating an example graphical user interface 200B, in accordance with some embodiments. The GUI 200B may be presented and/or displayed by a comparison module. The portion 210B may display/present a visual representation of a network topology and the visual representation may include shapes, colors, icons, images, text, etc., that represent the network devices and the connections of the network topology. As illustrated in FIG. 2B, the portion 210B includes icons 211, 212, 213, 214, 215, 217, 218, and 219. Each of the icons 211, 212, 213, 214, 215, 217, 218, and 219 may represent a network device (e.g., a switch, a router, etc.) that is part of the network topology represented by the visual representation displayed and/or presented in portion 210B. The portion 210B also includes lines interconnecting the icons 211, 212, 213, 214, 215, 217, 218, and 219. The lines may represent connections between the network devices of the network topology represented by the visual representation displayed and/or presented in portion 210B. Although the visual representation (of a network topology) presented/displayed in portion 210B may be a 2-D representation, a 3-D representation (e.g., an isometric view of the network topology) may be presented/displayed in other embodiments. The portion 210B also includes button 221. In one embodiment, the button 221 may allow a user to view different sections of the visual representation displayed/presented in portion 210B (as discussed above). In one embodiment, a touch pad or touch screen, instead of button 221, may allow a user to view different sections of the visual representation displayed/presented in portion 210B (as discussed above). The portion 210B further includes slider bar 222 and a slider 223. In one embodiment, the slider bar 222 and/or the slider 223 may allow a user to zoom in and/or zoom out (as discussed above). In one embodiment, a touch pad or touch screen, instead of slider bar 222 and/or slider 223, may allow a user to zoom in and/or zoom out (as discussed above). In one embodiment, a user may change the location and/or position of an icon in the visual representation displayed and/or presented in the portion 210B (as discussed above).

The GUI 200B also includes portion 250B. As illustrated in FIG. 2B, the portion 250B includes a list of network topologies. Each network topology in the list of network topologies is associated with a date/time and is associated with a checkbox. The checkboxes may allow the user to select one or more of the network topologies in the list of network topologies. In one embodiment, when one network topology is selected, the portion 210B may present and/or display a visual representation for the selected network topology. In another embodiment, when multiple network topologies are selected, the portion 210B may present and/or display a visual representation for one network topology of the selected network topologies. For example, as illustrated in FIG. 2B, the first network topology, the fourth network topology, and the fifth network topology in the list of network topologies are selected. A visual representation of the fourth network topology (e.g., the network topology associated with the date/time Mar. 24, 2015 at 16:04) is presented and/or displayed in the portion 210B, as indicated by the thicker rectangle (e.g., the bolded rectangle) around the fourth network topology.

As discussed above, two network topologies may include common network devices and/or common connections. For example, a subset of the network devices and/or connections in one network topology may be included in (e.g., part of) another network topology and vice versa. In one embodiment, visual representations for network topologies that include a common network device may present the icon for the common network device at the same location/position. For example, referring to FIG. 2A, portion 210A displays a visual representation of the first network topology that includes icons 211, 212, 213, 214, 215, and 217. The network devices represented by icons 211, 212, 213, 214, 215, and 217 are included in the first network topology. Referring to FIG. 2B, portion 210B displays a visual representation of the fourth network topology that also includes icons 211, 212, 213, 214, 215, and 217 because the network devices represented by icons 211, 212, 213, 214, 215, and 217 are also included in the first network topology. As illustrated in FIGS. 2A and 2B, the icons 211, 212, 213, 214, 215, and 217 are presented at the same locations/positions within the portions 210A and 210B, respectively. For example, icon 211 is presented and the same location/position in portion 210A (of GUI 200A) and in portion 210B (of GUI 200B).

As discussed above, a comparison module may alternate between presenting multiple visual representations of multiple network topologies at a rate or speed. For example, referring to FIGS. 2A and 2B, the GUI 200B may alternate between presenting/displaying visual representations for the first network topology, the fourth network topology, and the fifth network topology in the portion 210B. In one embodiment, the GUI 200B may periodically alternate between presenting/displaying visual representations for the first network topology and the fourth network topology, and the fifth network topology in the portion 210B. For example, the GUI 200B may alternate between presenting/displaying visual representations for the first network topology, the fourth network topology, the fifth network topology, and back to the first network topology, every second, two seconds, etc. In another embodiment, the GUI 200B may alternate between presenting/displaying visual representations for the first network topology and the fourth network topology, and the fifth network topology in the portion 210B, based on user input. For example, the GUI 200B may alternate between presenting/displaying visual representations for the first network topology, the fourth network topology, the fifth network topology, and back to the first network topology, each time user input is received (e.g., each time the user selects/activates an arrow key on a keyboard). In one embodiment, the GUI 200B may alternate between presenting/displaying visual representations for the first network topology, the fourth network topology, and the fifth network topology multiple times (e.g., may cycle between presenting/displaying the visual representations multiple times).

As discussed above, the rate/speed of the alternating between presenting the visual representations may induce (e.g., may be fast enough to induce) the persistence of vision effect in a user. As illustrated in FIGS. 2A and 2B, the first network topology is different from the fourth network topology. For example, the fourth network topology (illustrated in FIG. 2B) may not include the icon 216 (e.g., does not include the network device represented by icon 216) illustrated in FIG. 2A and does not include the connections between the icon 216 and the icons 214 and 212. The first network topology does not include the icons 218 and 219 (does not include the network devices represented by the icons 218 and 219) and does not include the connections to the icons 218 and 219. When the GUI 200B alternates between presenting the first network topology (illustrated in FIG. 2A) and the fourth network topology (illustrated in FIG. 2B), the persistence of vision effect may cause the icons 216, 218, and 219 to appear to blink (e.g., flicker, disappear/reappear). The blinking effect (which may be caused by the persistence of vision of the user) may allow a user to more easily identify the differences between the first network topology and the fourth network topology. For example, the blinking effect may allow a user to determine that the network device represented by icon 216 is included in the first network topology but is not included in the fourth network topology. In another example, the blinking effect may allow the user to determine that the network devices represented by icons 218 and 219 are not included in the fourth network topology but are included in the first network topology.

It shall be understood that the visual representation (of a network topology) presented in the portion 210B of the GUI 200B is merely an example. In other embodiments, visual representations (of network topologies) may include tens, hundreds, thousands, etc., of network devices and/or network connections. The blinking effect (caused by alternating between presenting the visual representations at a rate that is fast enough to induce the persistence of vision effect in a user) may also help the user to more quickly and/or efficiently identify differences between large network topologies. Identifying the differences between network topologies may allow users to more easily, quickly, and/or efficiently identify problems (or possible problems) within a network and address the problems.

In one embodiment, a comparison module (e.g., comparison module 111 illustrated in FIG. 1) may determine whether visual representations of the network topologies selected by a user are comparable. For example, the first network topology, the fourth network topology, and the fifth network topology have been selected by the user (as illustrated by the checkboxes in portion 250B). The comparison module may determine whether the visual representations for the first network topology, the fourth network topology, and the fifth network topology are comparable. The comparison module may alternate between the visual representations when the visual representations are comparable. In one embodiment, the comparison module may determine whether visual representations of the network topologies selected by a user are comparable based on a number of common network devices and/or connections that are included in the selected network topologies. In one embodiment, the comparison module may determine that visual representations of the network topologies selected by a user are comparable when the selected network topologies include a threshold number (e.g., a minimum number) of common network devices and/or connections. For example, the comparison module may determine that the visual representations of the network topologies selected by a user are comparable when the selected network topologies include ten (or more) common network devices (e.g., each of the selected network topologies includes the same ten or more common network devices). In another embodiment, the comparison module may determine that visual representations of the network topologies selected by a user are comparable when the selected network topologies includes a threshold percentage of common network devices and/or connections. For example, the comparison module may determine that the visual representations of the network topologies selected by a user are comparable when fifty percent (or more) of the network devices in the selected network topologies are common.

FIG. 2C is a diagram illustrating an example graphical user interface, in accordance with some embodiments. The GUI 200C may be presented and/or displayed by a comparison module. The portion 210C may display/present a visual representation of a network topology and the visual representation may include shapes, colors, icons, images, text, etc., that represent the network devices and the connections of the network topology. As illustrated in FIG. 2C, the portion 210C includes icons 211, 212, 213, 214, 215, 216, 217, 218, and 219. Each of the icons 211, 212, 213, 214, 215, 216, 217, 218, and 219 may represent a network device (e.g., a switch, a router, etc.) that is part of the network topology represented by the visual representation displayed and/or presented in portion 210C. The portion 210C also includes lines interconnecting the icons 211, 212, 213, 214, 215, 216, 217, 218, and 219. The lines may represent connections between the network devices of the network topology represented by the visual representation displayed and/or presented in portion 210C. Although the visual representation presented/displayed in portion 210C may be a 2-D representation, a 3-D representation may be presented/displayed in other embodiments. The portion 210C also includes button 221. In one embodiment, the button 221 may allow a user to view different sections of the visual representation displayed/presented in portion 210C (as discussed above). In one embodiment, a touch pad or touch screen, instead of button 221, may allow a user to view different sections of the visual representation displayed/presented in portion 210B (as discussed above). The portion 210C further includes slider bar 222 and a slider 223. In one embodiment, the slider bar 222 and/or the slider 223 may allow a user to zoom in and/or zoom out (as discussed above). In one embodiment, a touch pad or touch screen, instead of slider bar 222 and/or slider 223, may allow a user to zoom in and/or zoom out (as discussed above). In one embodiment, a user may change the location and/or position of an icon in the visual representation displayed and/or presented in the portion 210C (as discussed above).

The GUI 200C also includes portion 250C. As illustrated in FIG. 2C, the portion 250C includes a list of network topologies. Each network topology in the list of network topologies is associated with a date/time and is associated with a checkbox. The checkboxes may allow the user to select one or more of the network topologies in the list of network topologies. In one embodiment, when one network topology is selected, the portion 210C may present and/or display a visual representation for the selected network topology. In another embodiment, when multiple network topologies are selected, the portion 210C may present and/or display a visual representation for one network topology of the selected network topologies. For example, as illustrated in FIG. 2C, the first network topology, the fourth network topology, and the fifth network topology in the list of network topologies are selected. A visual representation of the fourth network topology (e.g., the network topology associated with the date/time Mar. 24, 2015 at 16:04) is presented and/or displayed in the portion 210C, as indicated by the thicker rectangle (e.g., the bolded rectangle) around the fourth network topology.

In one embodiment, the comparison module 111 may identify one or more differences (e.g., a set of differences) between network topologies (e.g., between network topologies selected by a user). For example, referring to FIGS. 2A and 2B, the first network topology (illustrated in FIG. 2A) does not include the icons 218 and 219 of the fourth network topology (illustrated in FIG. 2B). The fourth network topology (illustrated in FIG. 2B) does not include the icon 216 of the first network topology (illustrated in FIG. 2A). The comparison module may identify the network devices represented by icons 216, 218, and 219 as differences (e.g., a set of differences) between the first network topology (illustrated in FIG. 2A) and the fourth network topology (illustrated in FIG. 2A). In another embodiment, the comparison module 111 may present and/or display a visual representation of the differences between network topologies (e.g., between network topologies selected by a user). For example, the comparison module 111 may highlight the icons 216, 218, and 219 displayed/presented in the portion 210C with a color (e.g., red, yellow, etc.). In another example, the comparison module may outline the icons 216, 218, and 219 with geometric shapes (e.g., squares, circles, rectangles, etc.). As illustrated in FIG. 2C, icon 216 is outlined with circle 241, icon 218 is outlined with rectangle 242, and icon 219 is outlined with rectangle 243. In another example, the comparison module may alternate sizes of icons 216, 218, and 219 to make the icons appear to pulsate. In other embodiments, the comparison module 111 may use other types of visual indicators and/or text to indicate the differences between network topologies.

In one embodiment, the comparison module may receive user input indicating one or more annotations (e.g., icons, notes, text, images, highlights, etc.) associated with a visual representation. As illustrated in FIG. 2C, the portion 210C includes an annotation 231. The annotation 231 may be a text box that may include notes and/or information provided by a user. The one or more annotations may allow the user to add notes and/or information about the network devices/connections of a network topology and/or about changes to the network devices/connections, to the visual representation of the network topology. For example, the annotation 231 includes the text “Switch down for maintenance until 03/25/15.” The annotation 231 may allow the user to add a note indicating that the network device represented by the icon 216 is not included in a network topology (e.g., the network device was taken offline for maintenance). In other embodiments, the annotations may include other types of data and/or information. For example, the user may add a voice recording as an annotation in a visual representation and the GUI 200C may display an icon in the portion 210C (or other image) indicating that a voice recording (e.g., an annotation) is available for playback.

In one embodiment, the one or more annotations may be stored as part of a visual representation. For example, referring to FIG. 1, one or more annotations may be included as part of the representation data 121 in the data store 120. In another embodiment, the one or more annotations may be stored separately from a visual representation. For example, referring to FIG. 1, the data store 120 may include additional data (e.g., additional files, database entries, etc.) that may include the one or more annotations. The additional data (that includes the one or more annotations) may also identify which visual representation (and/or which network topology) is associated with the one or more annotations.

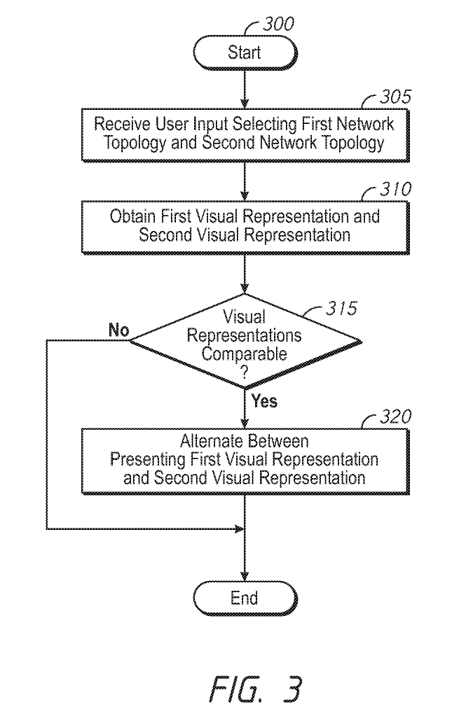

FIG. 3 is a flowchart representation of a method 300 of comparing network topologies, in accordance with some embodiments. In some implementations, the method 300 may be performed by a comparison module and/or computing device (e.g., comparison module 111 and/or computing device illustrated in FIG. 1). The comparison module and/or computing device may include hardware (e.g., circuitry, dedicated logic, programmable logic, microcode, etc.), software (e.g., instructions run on a processor to perform hardware simulation), firmware, or a combination thereof. Briefly, method 300 includes obtaining visual representations and alternating between presenting the visual representations. The method 300 begins at block 305 where the method 300 includes receiving user input selecting and/or identifying a first network topology and a second network topology. For example, referring to FIGS. 2A through 2C, a user may use the check boxes to provide user input identifying or selecting a plurality of network representations (as discussed above). In other embodiments, user input selecting and/or identifying multiple network topologies (e.g., three network topologies, eight network topologies, etc.) may be received.

At block 310, the method 300 includes obtaining a first visual representation and a second visual representation. In one embodiment, method 300 may include generating the first visual representation and the second visual representation. For example, referring to FIG. 1, the method 300 may include receiving the network data 122 and generating the first visual representation and the second visual representation based on network data 122. In another embodiment, the method 300 may include receiving the first visual representation and the second visual representation. For example, the first visual representation and the second visual representation may be received from a computing device (e.g., a server) that previously generated the first visual representation and the second visual representation. In other embodiments, the method 300 may include obtaining (e.g., generating and/or receiving) multiple visual representations (e.g., ten visual representations, twenty visual representations, etc.).

At block 315, the method 300 includes determining whether the first visual representation and the second visual representation are comparable. For example, as discussed above, the method 300 may include determining whether the first visual representation and the second visual representation include a threshold number of common network devices. In another example, as discussed above, the method 300 may include determining whether a threshold percentage of network devices in the first visual representation and the second visual representation are common network devices. If the first visual representation and the second visual representation are not comparable, the method 300 ends.

If the first visual representation and the second visual representation are comparable, the method 300 includes alternating between presenting the first visual representation and the second visual representation at block 320. For example, as discussed above, the method 300 may include alternating between presenting the first visual representation and the second visual representation (in a GUI, such as GUI 200A, GUI 200B, and/or GUI 200C discussed above). In one embodiment, the method 300 may include alternating between presenting the first visual representation and the second visual representation based on user input (e.g., alternating between presenting the first visual representation and the second visual representation each time a user selects and/or activates a key on a keyboard). In another embodiment, the method 300 may include alternating between presenting the first visual representation and the second visual representation periodically (e.g., alternating between presenting the first visual representation and the second visual representation every half a second, every second, every three seconds, etc.). For example, the method 300 may alternate between presenting the first visual representation and the second visual representation until the user selects and/or activates a key on a keyboard, touch pad, or touch screen to stop the alternating display. In other embodiments, the method 300 may include alternating between presenting multiple visual representations (e.g., three visual representations, ten visual representations). As discussed above, the rate of alternating between presenting the visual representations may be fast enough to induce the persistence of vision effect (e.g., a blinking effect) of a user viewing the visual representations.

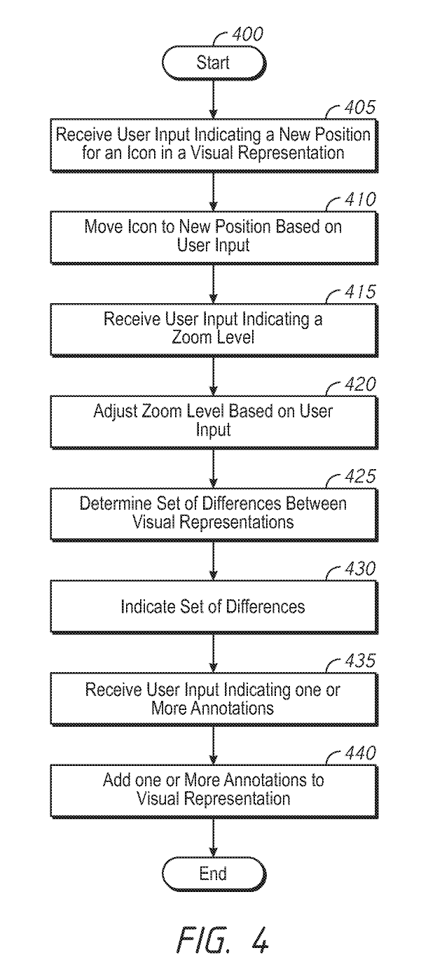

FIG. 4 is a flowchart representation of a method 400 of comparing network topologies, in accordance with some embodiments. In some implementations, the method 400 may be performed by a comparison module and/or computing device (e.g., comparison module 111 and/or computing device illustrated in FIG. 1). The comparison module and/or computing device may include hardware (e.g., circuitry, dedicated logic, programmable logic, microcode, etc.), software (e.g., instructions run on a processor to perform hardware simulation), firmware, or a combination thereof. Briefly, method 400 may include moving an icon, adjusting a zoom level, indicating differences in network topologies, and/or adding one or more annotations to a visual representation. The method 400 begins at block 405 where the method 400 includes receiving user input indicating a new position for an icon (or multiple icons) in a visual representation. For example, referring to FIG. 2A, a user may select an icon (e.g., icon 211) presented in the portion 210A of the GUI 200A. At block 410, the method 400 may include moving the icon to a new position/location based on the user input or received location data (as discussed above). For example, referring to FIG. 2A, the GUI 200A may present/display the icon 211 in a different position/location based on the user selecting and/or dragging an icon to the different location/position and/or based on new location data received from the network resulting in icon 211 to be displayed in the corresponding, new position (as discussed above).

At block 415, the method 400 may include receiving user input indicating a zoom level. For example, referring to FIG. 2A, the user may move the slider 223 upwards along the slider bar 222. Alternatively, the user may change zoom levels via touch pad or touch screen. The method 400 may adjust the zoom level based on the user input at block 420 (as discussed above). For example, referring to FIG. 2A, the GUI 200A may zoom into the visual representation presented/displayed in portion 210A (as discussed above). At block 425, the method 400 may determine and/or identify a set of differences between multiple visual representations (e.g., between two visual representations). For example, the method 400 may identify network devices and/or connections that are in one visual representation but not in another visual representation, and vice versa. The method 400 may indicate the set of differences at block 430 (as discussed above). For example, referring to FIG. 2C, the method 400 may highlight icon 216. In another example, referring to FIG. 2C, the method 400 may outline icon 216 with a geometric shape. In a further example, the method 400 may alternate the size of icon 216 (as described above).

At block 435, the method 400 may receive user input indicating one or more annotations associated with a visual representation. For example, the method 400 may receive text, images, icons, an audio recording, etc. In one embodiment, the method 400 may add one or more annotations to the visual representation (as discussed above). For example, referring to FIG. 2C, the method 400 may add a text box (e.g., annotation 231) to the visual representation displayed in portion 210C.

It shall be understood that in some embodiments, some of the blocks in the method 400 may be optional. For example, blocks 405 and 410 may not be performed if the method 400 does not receive user input indicating a new position for an icon in a visual representation. In another example, blocks 415 and 420 may not be performed if the method 400 does not receive user input indicating a zoom level. In a further example, blocks 425 and 430 may not be performed if only one network topology is selected. In yet another example, block 430 may not be performed if the visual representations are not comparable (as described above). In yet another example, blocks 435 and 440 may not be performed if the method 400 does not receive user input indicating one or more annotations.

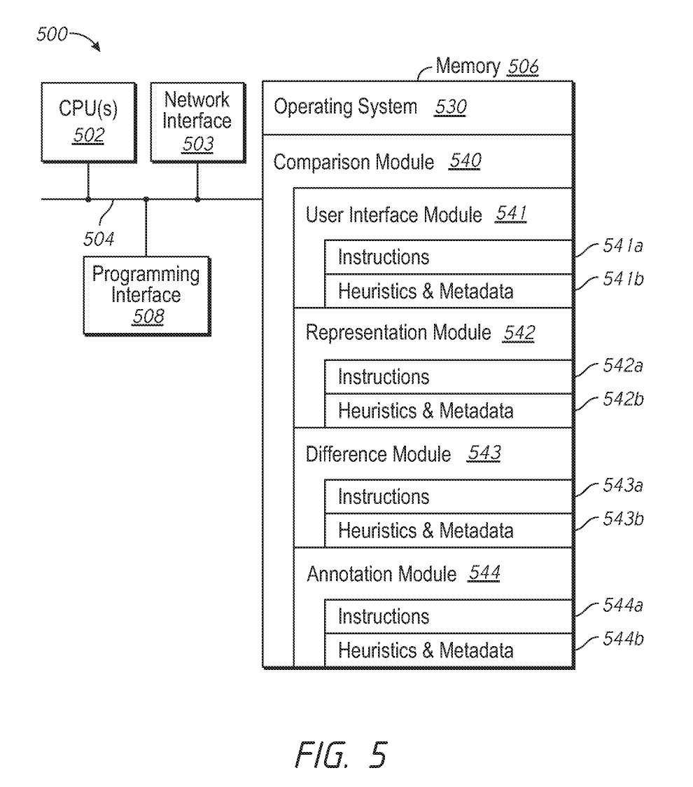

FIG. 5 is a block diagram of a computing device 500, in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the computing device 500 includes one or more processing units (CPU's) 502 (e.g., processors), one or more output interfaces 503, a memory 506, a programming interface 508, and one or more communication buses 504 for interconnecting these and various other components and network devices (106 in FIG. 1).

In some embodiments, the communication buses 504 include circuitry that interconnects and controls communications between system components and communication with network devices (106 in FIG. 1). The memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 506 optionally includes one or more storage devices remotely located from the CPU(s) 502. The memory 506 comprises a non-transitory computer readable storage medium. Moreover, in some embodiments, the memory 506 or the non-transitory computer readable storage medium of the memory 506 stores the following programs, modules and data structures, or a subset thereof including an optional operating system 530 and a comparison module 540. In some embodiment, one or more instructions are included in a combination of logic and non-transitory memory. The operating system 530 includes procedures for handling various basic system services and for performing hardware dependent tasks. In some embodiments, the comparison module 540 may be configured to obtain visual representations, alternate between presenting multiple visual representations, determine differences in visual representations, adjust the view of visual representations, and add annotations to visual representations. To that end, the comparison module 540 includes a user interface module 541, a representation module 542, a difference module 543, and an annotation module 544.

In some embodiments, the user interface module 541 may present a user interface and may alternate between presenting different visual representations of network topologies. To that end, the user interface module 541 includes a set of instructions 541a and heuristics and metadata 541b. In some embodiments, the representation module 542 may generate and/or obtain visual representations of network topologies. To that end, the representation module 542 includes a set of instructions 542a and heuristics and metadata 542b. In some embodiments, the difference module 543 may determine differences between network topologies, may indicate the differences on a GUI, and may determine whether visual representations are comparable. To that end, the difference module 543 includes a set of instructions 543a and heuristics and metadata 543b. In some embodiments, the annotation module 544 may add annotations to visual representations. To that end, the annotation module 544 includes a set of instructions 544a and heuristics and metadata 544b.

Although the comparison module 540, the user interface module 541, the representation module 542, the difference module 543, and the annotation module 544 are illustrated as residing on a single computing device 500, it should be understood that in other embodiments, any combination of the comparison module 540, the user interface module 541, the representation module 542, the difference module 543, and the annotation module 544 may reside on separate physical or virtual computing devices.

Moreover, FIG. 5 is intended more as functional description of the various features which may be present in a particular embodiment as opposed to a structural schematic of the embodiments described herein. As recognized by those of ordinary skill in the art, items shown separately could be combined and some items could be separated. For example, some functional modules shown separately in FIG. 5 could be implemented in a single module and the various functions of single functional blocks could be implemented by one or more functional blocks in various embodiments. The actual number of modules and the division of particular functions and how features are allocated among them will vary from one embodiment to another, and may depend in part on the particular combination of hardware, software and/or firmware chosen for a particular embodiment.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged, certain steps may be repeated repeatedly, and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

It will also be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact. Also as used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

Further as used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method comprising:
obtaining a first visual representation of a first network topology of a network and a second visual representation of a second network topology, wherein the first network topology comprises a first set of network devices and a first set of connections between the first set of network devices and wherein the second network topology comprises a second set of network devices and a second set of connections between the second set of network devices; and
alternating between presenting the first visual representation and presenting the second visual representation based on user input.

2. The method of claim 1, wherein obtaining the first visual representation and the second visual representation comprises:
receiving first data indicative of the first network topology and second data indicative of a second network topology;
generating the first visual representation based on the first data; and
generating the second visual representation based on the second data.

3. The method of claim 1, wherein obtaining the first visual representation and the second visual representation comprises:
receiving the first visual representation and the second visual representation from a server.

4. The method of claim 1, wherein the first network topology is associated with a first time and wherein the second network topology is associated with a second time.

5. The method of claim 1, wherein a rate of alternating between the presenting the first visual representation and presenting the second visual representation induces a persistence of vision effect in a user.

6. The method of claim 1, further comprising:
adjusting a zoom level for one or more of the first visual representation and a second visual representation.

7. The method of claim 1, wherein the first visual representation and the second visual representation comprise a set of common network devices, wherein the set of common network devices are presented at common locations within the first visual representation and the second visual representation, and wherein first visual representation and the second visual representation represent snapshots obtained at scheduled times or obtained based on a notification of a change in the first network topology.

8. The method of claim 1, further comprising:
obtaining a third visual representation of a third network topology, wherein the third network topology comprises a third set of network devices and a third set of connections between the third set of network devices; and
alternating between presenting the first visual representation, presenting the second visual representation, and presenting the third visual representation based on user input.

9. The method of claim 1, further comprising:
determining a set of differences between the first network topology and the second network topology; and
indicating the set of differences on one or more of the first visual representation or the second visual representation.

10. The method of claim 1, further comprising:
receiving user input indicative of one or more annotations associated with one or more of the first visual representation or the second visual representation; and
adding the one or more annotations to one or more of the first visual representation or the second visual representation.

11. The method of claim 1, wherein obtaining the first visual representation and the second visual representation is based on user input identifying the first network topology and the second network topology.

12. The method of claim 1, wherein the first visual representation and the second visual representation comprise one or more of 2-dimensional (2-D) representations or 3-dimensional (3-D) representations.

13. The method of claim 1, further comprising:
determining whether the first visual representation and the second visual representation are comparable; and
alternating between presenting the first visual representation and presenting the second visual representation when the first visual representation and the second visual representation are comparable.

14. An apparatus, comprising:
one or more processors; and
a memory comprising instructions that when executed cause the one or more processors to perform operations comprising:
obtaining a first visual representation of a first network topology of a network and a second visual representation of a second network topology, wherein the first network topology comprises a first set of network devices and a first set of connections between the first set of network devices and wherein the second network topology comprises a second set of network devices and a second set of connections between the second set of network devices; and
alternating between presenting the first visual representation and presenting the second visual representation based on user input.

15. The apparatus of claim 14, wherein obtaining the first visual representation and the second visual representation comprises:
receiving first data indicative of the first network topology and second data indicative of a second network topology;
generating the first visual representation based on the first data; and
generating the second visual representation based on the second data.

16. The apparatus of claim 14, wherein obtaining the first visual representation and the second visual representation comprises:
receiving the first visual representation and the second visual representation from a server.

17. The apparatus of claim 14, wherein a rate of alternating between the presenting the first visual representation and presenting the second visual representation induces a persistence of vision effect in a user.

18. The apparatus of claim 14, wherein the first visual representation and the second visual representation comprise a set of common network devices, wherein the set of common network devices are presented at common locations within the first visual representation and the second visual representation, and wherein first visual representation and the second visual representation represent snapshots obtained at scheduled times or obtained based on a notification of a change in the first network topology.

19. The apparatus of claim 14, further comprising:
obtaining the first visual representation and the second visual representation is further based on user input identifying the first network topology and the second network topology.

20. A non-transitory computer readable storage medium comprising instructions that, when executed by one or more processors, cause the one or more processors to perform operations comprising:
obtaining a first visual representation of a first network topology of a network and a second visual representation of a second network topology, wherein the first network topology comprises a first set of network devices and a first set of connections between the first set of network devices and wherein the second network topology comprises a second set of network devices and a second set of connections between the second set of network devices; and
alternating between presenting the first visual representation and presenting the second visual representation based on user input.
